(19) United States
(12) Patent Application Publication
(10) Pub. No.: US 2026/0269989 A1
(43) Pub. Date: Sep. 10, 2026

(54) METHOD AND APPARATUS FOR HYBRID AUTOMATIC REPEAT REQUEST ENHANCEMENTS FOR MULTIPLE TRANSPORT BLOCKS SCHEDULING IN AN INTERNET-OF-THINGS SYSTEM

(71) Applicant: MediaTek Singapore Pte. Ltd., Singapore (SG)

(72) Inventor: Wen TANG, Beijing (CN)

(21) Appl. No.: 19/166,242

(22) PCT Filed: Jun. 5, 2024
(86) PCT No.: PCT/CN2024/097418

§ 371 Date: Sep. 17, 2025

(30) Foreign Application Priority Data
Jun. 14, 2023 (WO) PCT/CN2023/100152

(51) Int. Cl. H04L 1/1829; H04W 72/232

(52) U.S. Cl. CPC H04L 1/1854; H04W 72/232

(57) ABSTRACT

Various solutions for hybrid automatic repeat request (HARQ) enhancements for multiple transport blocks (multi-TB) scheduling in an Internet-of-Things (IoT) system are described. An apparatus may receive a configuration from a network node of a wireless network. The configuration indicates disabled or enabled HARQ feedback information for each or all of a plurality of HARQ processes. The apparatus may receive a DCI from the network node. The DCI indicates a scheduling of multiple TBs associated with the HARQ processes in a narrowband physical downlink shared channel (NPDSCH). The apparatus may perform a NPDSCH reception for the TBs based on the DCI. The apparatus may determine whether to report one or more HARQ feedbacks corresponding to the TBs based on the configuration.

### CROSS REFERENCE TO RELATED PATENT APPLICATION(S)

The present disclosure is part of a non-provisional application claiming the priority benefit of PCT Application No. PCT/CN2023/100152, filed 14 Jun. 2023, the content of which herein being incorporated by reference in its entirety.

### TECHNICAL FIELD

The present disclosure is generally related to mobile communications and, more particularly, to hybrid automatic repeat request (HARQ) enhancements for multiple transport blocks (multi-TB) scheduling in an Internet-of-Things (IoT) system.

### BACKGROUND

Unless otherwise indicated herein, approaches described in this section are not prior art to the claims listed below and are not admitted as prior art by inclusion in this section.

For current network implementations, one base station (BS) is operable to provide radio coverage to a specific geographical area using a plurality of cells forming a radio access network. The BS may support the operations of the plurality of cells, and each cell may be operable to provide services to at least one user equipment (UE) within its radio coverage. Specifically, each cell may provide services to serve one or more UEs within its radio coverage based on at least one downlink control information (DCI), where a radio coverage of one cell may overlap with another radio coverage of other cell(s). In an Internet-of-Things (IoT) system, a cell may schedule multiple uplink/downlink (UL/DL) resources (e.g., TBs) to one UE within its radio coverage by a DCI for performing UL/DL transmissions, e.g., UL HARQ feedback transmissions. HARQ is a mechanism to improve transmission reliability and robustness. With the HARQ mechanism, the UE needs to report HARQ feedback information for a corresponding DL transmission to the scheduling cell, such that the scheduling cell knows whether the DL transmission is successful and decides the next DL transmission to be a new transmission or retransmission.

In 3^{rd} Generation Partnership Project (3GPP) Release 17, the concept of enabled/disabled HARQ feedback information is introduced, wherein disabled HARQ feedback information is designed to improve throughput in scenarios with large transmission delay, such as non-terrestrial network (NTN). However, when applying the concept of enabled/disabled HARQ feedback information to IoT systems, detailed HARQ operations have not been fully discussed yet and some issues need to be solved. For example, one issue relates to how or when to transmit HARQ feedback. Another issue relates to how to design the no narrowband physical downlink control channel (NPDCCH) monitoring restriction in the HARQ operations for multi-TB scheduling.

Therefore, there is a need to provide proper schemes to address these issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to HARQ operations in applying enabled/disabled HARQ feedback information for multi-TB scheduling in IoT systems.

In one aspect, a method may involve an apparatus receiving a configuration from a network node of a wireless network, wherein the configuration indicates disabled or enabled HARQ feedback information for each or all of a plurality of HARQ processes. The method may involve the apparatus receiving a DCI from the network node, wherein the DCI indicates a scheduling of multiple TBs associated with the HARQ processes in a NPDSCH. The method may also involve the apparatus performing a NPDSCH reception for the TBs based on the DCI. The method may further involve the apparatus determining whether to report one or more HARQ feedbacks corresponding to the TBs based on the configuration.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising receiving, via the transceiver, a configuration from the network node, wherein the configuration indicates disabled or enabled HARQ feedback information for each or all of a plurality of HARQ processes. The processor may perform operations comprising receiving, via the transceiver, a DCI from the network node, wherein the DCI indicates a scheduling of multiple TBs associated with the HARQ processes in a NPDSCH. The processor may also perform operations comprising performing, via the transceiver, a NPDSCH reception for the TBs based on the DCI. The processor may further perform operations comprising determining whether to report one or more HARQ feedbacks corresponding to the TBs based on the configuration.

It is noteworthy that, although description provided herein may be in the context of certain radio access technologies, networks and network topologies such as Long-Term Evolution (LTE), LTE-Advanced, LTE-Advanced Pro, 5^{th} Generation (5G), New Radio (NR), Internet-of-Things (IoT) and Narrow Band Internet of Things (NB-IoT), Industrial Internet of Things (IIoT), beyond 5G (B5G), and 6^{th} Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario of HARQ operations with enabled/disabled HARQ feedback information in accordance with an implementation of the present disclosure.

FIG. 3 is a diagram depicting an example scenario of configuration indication for enabled/disabled HARQ feedback information for multi-TB in accordance with an implementation of the present disclosure.

FIG. 4 is a block diagram of an example communication system in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to HARQ enhancements for multi-TB scheduling in an IoT system. According to the present disclosure, a number of possible solutions may be implemented separately or jointly. That is, although these possible solutions may be described below separately, two or more of these possible solutions may be implemented in one combination or another.

The HARQ mechanism is mainly used for scheduling management, such as the initial transmission and retransmission of information. In scenarios with relatively small transmission delay, such as TN system, using HARQ feedback for DL transmissions have many advantages, such as increasing transmission reliability. On the other hand, in scenarios with large transmission delay, such as NTN system, disabling HARQ feedback for DL transmissions may reduce UE power consumption and improve UL throughput. Accordingly, considering the IoT (e.g., IoT NTN) scenarios, the present disclosure proposes schemes of HARQ enhancements for multi-TB scheduling in an IoT system, to mitigate HARQ stalling and reduce UE power consumption.

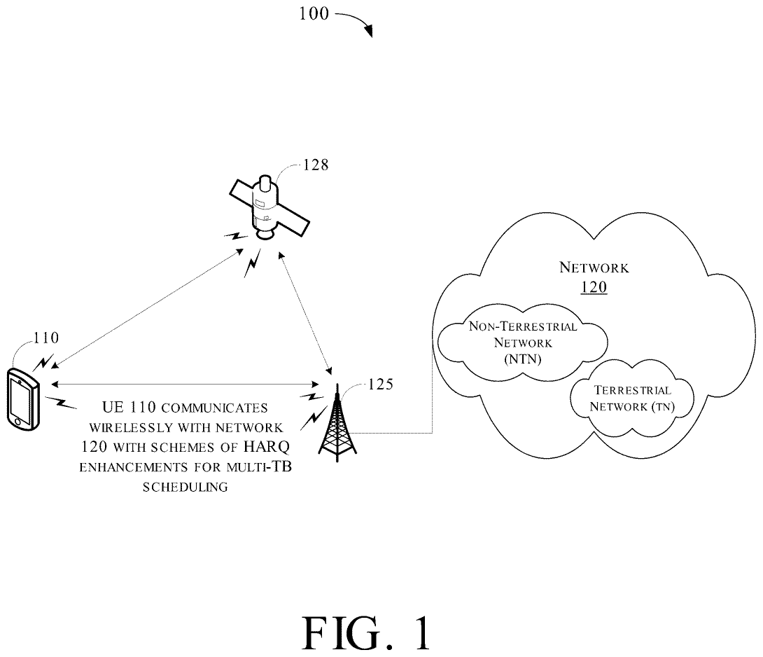

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 125 (e.g., an evolved Node-B (eNB), a Next Generation Node-B (gNB), or a transmission/reception point (TRP)) and/or a non-terrestrial network node 128 (e.g., a satellite). For example, the terrestrial network node 125 and/or the non-terrestrial network node 128 may form an NTN serving cell for wireless communication with the UE 110. In some implementations, the network 120 may be an IoT network (e.g., an NTN IoT network), and the UE 110 may be an IoT device such as an NB-IOT UE or an eMTC UE (e.g., a bandwidth reduced low complexity (BL) UE or a coverage enhancement (CE) UE). In such communication environment, the UE 110, the network 120, and the terrestrial network node 125 and/or the non-terrestrial network node 128 may implement various schemes pertaining to HARQ enhancements for multi-TB scheduling in an IoT system in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In the present disclosure, NTN refers to a network that uses radio frequency (RF) and information processing resources carried on high, medium and low orbit satellites or other high-altitude communication platforms to provide communication services for UEs. According to the load capacity on the satellite, there are two typical scenarios, namely: transparent payload and regenerative payload. In transparent payload mode, the satellite does not process the signal and waveform in the communication service but, rather, only functions as an RF amplifier to forward data. In regenerative payload mode, the satellite, other than RF amplification, also has the processing capabilities of modulation/demodulation, coding/decoding, switching, routing and so on.

In general, an IoT system is mainly divided into NB-IOT and eMTC based on differences in system bandwidth and coverage. Typically, the bandwidth used in NB-IoT is about 200 kilo-hertz (KHz) and supports the transmission of low traffic data at a rate below 100 kilobits per second (Kbps). Conversely, eMTC technology typically utilizes 1.4 mega-hertz (MHz) bandwidth and the maximum data transmission rate is 1 megabits per second (Mbps). For eMTC, different TBs corresponding to different HARQ process number may be scheduled by a DCI. For NB-IoT, multiple TBs (i.e., two TBs) may be scheduled together by a DCI without HARQ process number field in the DCI, where HARQ process ID of 0 shall be assumed for the first TB and HARQ process ID of 1 shall be assumed for the second TB.

Under certain proposed schemes in accordance with the present disclosure, a configuration indicating disabled or enabled HARQ feedback information for each or all of a plurality of HARQ processes may be provided to the UE via radio resource control (RRC) signaling and/or a DCI field, before receiving a DCI indicating a scheduling of multiple TBs associated with the plurality of HARQ processes in the narrowband physical downlink shared channel (NPDSCH). For RRC-based indication, a bitmap may be used to indicate disabled/enabled HARQ feedback information for each HARQ process. For example, the RRC bitmap may include 2 bits (for NB-IoT cases) or 14 bits (for eMTC cases), each indicates disabled/enabled HARQ feedback information for a HARQ process (e.g., value 1 indicates disabled, and value 0 indicates enabled). For DCI-based indication, a single bit may be used to indicate disabled/enabled HARQ feedback information for all HARQ processes (e.g., value 1 indicates disabled, and value 0 indicates enabled). After performing a NPDSCH reception for the scheduled TBs based on the DCI, the UE may determine whether to report one or more HARQ feedbacks (e.g., HARQ acknowledgement (ACK) or non-acknowledgement (NACK)) corresponding to the TBs based on the configuration. More specifically, the UE may determine to report the one or more HARQ feedbacks corresponding to the TBs associated with the HARQ processes with enabled HARQ feedback information as indicated by the configuration, and determine not to report any HARQ feedback corresponding to the TBs associated with the HARQ processes with disabled HARQ feedback information as indicated by the configuration.

In some implementations, if HARQ-ACK bundling is configured (e.g., if the UE is configured with a higher layer parameter harq-AckBundling in npdsch-MultiTB-Config), the UE may report a single HARQ feedback which is generated by performing a logical AND operation of the HARQ feedbacks corresponding to the TBs associated with the HARQ processes with enabled HARQ feedback information, or by performing a logical AND operation of the HARQ feedbacks corresponding to the TBs and assuming 1 in the logical AND operation for the TBs associated with the HARQ processes with disabled HARQ feedback information.

In some implementations, if HARQ-ACK bundling is not configured, the UE may report one or multiple HARQ feedbacks, each corresponding to a respective one of the TBs associated with the HARQ processes with enabled HARQ feedback information.

In some implementations, the TBs associated with the HARQ processes with enabled HARQ feedback information may be configured in multiple TB bundles A_{b}, where b=1, ..., M_{enabled}. The reported HARQ feedback(s) may include multiple HARQ feedbacks (e.g., M_{enabled} HARQ-ACK bits, where M_{enabled} is the number of TB bundles that have TBs configured with enabled HARQ feedback information) generated by performing a logical AND operation of HARQ feedbacks across all TBs in each of the TB bundles.

In some implementations, the TBs may be configured in multiple TB bundles A_{b}, where b=1, ..., M. The reported HARQ feedback(s) may include multiple HARQ feedbacks (e.g., M HARQ-ACK bits, where M is the number of TB bundles given by 3GPP technical specification (TS) 36.213, Table 7.3-1) generated by performing a logical AND operation of HARQ feedbacks across all TBs and assuming 1 in the logical AND operation for the TBs associated with the HARQ processes with disabled HARQ feedback information in each of the TB bundles.

In some implementations, for no NPDCCH/PDCCH monitor restriction, the UE may determine not to perform DCI monitoring on NPDCCH or PDCCH in a first period of time subsequent to reporting of the one or more HARQ feedbacks, in an event that at least one of the TBs is associated with the HARQ processes with enabled HARQ feedback information. For example, the first period of time T1 may include the UE-to-eNB/gNB round-trip time (RTT), e.g., T1=UE_eNB_RTT+3 milliseconds (ms). Alternatively, the first period of time T1 may include the offset K_{mac} for delaying an application of a DL configuration indicated by a medium access control (MAC) control element (CE) command on PDSCH, e.g., T1=K_{mac}+3 ms.

In some implementations, for no NPDCCH/PDCCH monitor restriction, the UE may determine not to perform DCI monitoring in a second period of time subsequent to the NPDSCH reception, in an event that all of the TBs are associated with the HARQ processes with disabled HARQ feedback information. For example, the second period of time T2 may include a half-duplex guard period (e.g., T2=Type B half-duplex guard period (1ms)).

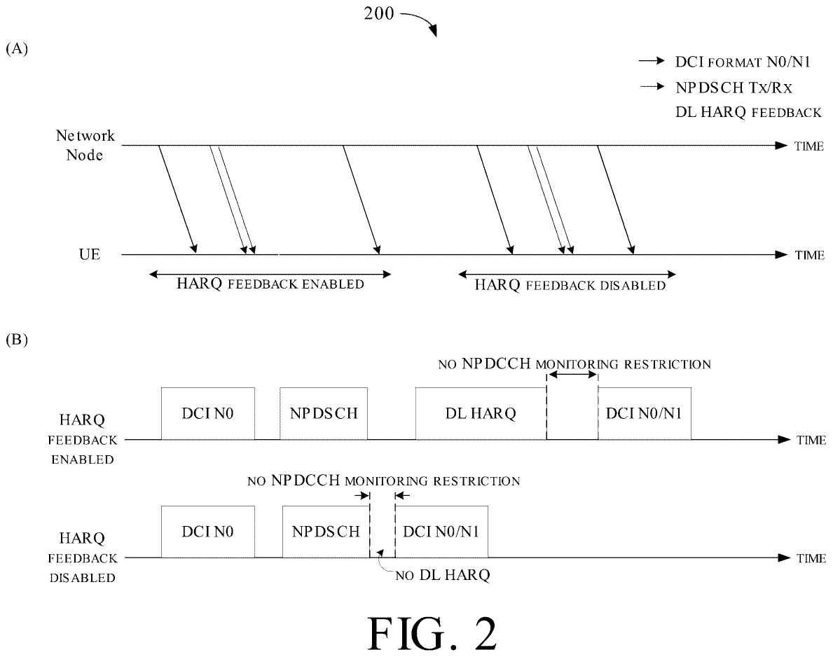

FIG. 2 illustrates an example scenario 200 of HARQ operations with enabled/disabled HARQ feedback information in accordance with an implementation of the present disclosure. Scenario 200 involves a UE (e.g., a NB-IoT UE, or an eMTC UE) and a network node (e.g., an eNB/gNB/TRP) implementing proposed schemes pertaining to HARQ enhancements for multi-TB scheduling in an IoT system in accordance with the present disclosure. Part (A) of FIG. 2 depicts, from left to right, the HARQ operations with enabled HARQ feedback information and the HARQ operations with disabled HARQ feedback information. During the HARQ operations with enabled HARQ feedback information, the UE receives a DCI (e.g., DCI format NO) indicating a scheduling of multiple TBs on NPDSCH and transmits the DL HARQ feedbacks for the scheduled TBs to the network node (e.g., an eNB/gNB/TRP). Based on the DL HARQ feedback, the network node may transmit a DCI to indicate the next transmission (e.g., a new transmission or a retransmission). For example, DCI format NO is utilized for NPDSCH scheduling, DCI format N1 is utilized for narrowband physical uplink shared channel (NPUSCH) scheduling, a DCI format 6-1a/b is utilized for NPDSCH scheduling for eMTC, and DCI format 6-0a/b is utilized for NPUSCH scheduling for eMTC, etc. During the HARQ operations with disabled HARQ feedback information, the UE receives a DCI (e.g., DCI format NO) indicating a scheduling of multiple TBs on NPDSCH and does not transmit any DL HARQ for the scheduled TBs to the network node, such that the network node may initiate the next transmission without waiting for the DL HARQ feedbacks. Part (B) of FIG. 2 depicts the HARQ operations with enabled HARQ feedback information in the upper diagram and the HARQ operations with disabled HARQ feedback information in the lower diagram. As shown in Part (B) of FIG. 2, the no NPDCCH monitoring restriction in the case of disabled HARQ feedback information is more relaxed than the no NPDCCH monitoring restriction in the case of enabled HARQ feedback information, considering that the UE may need more time to prepare for the switching between the NPUSCH transmission carrying the DL HARQ feedback and the next DCI reception when HARQ feedback information is enabled.

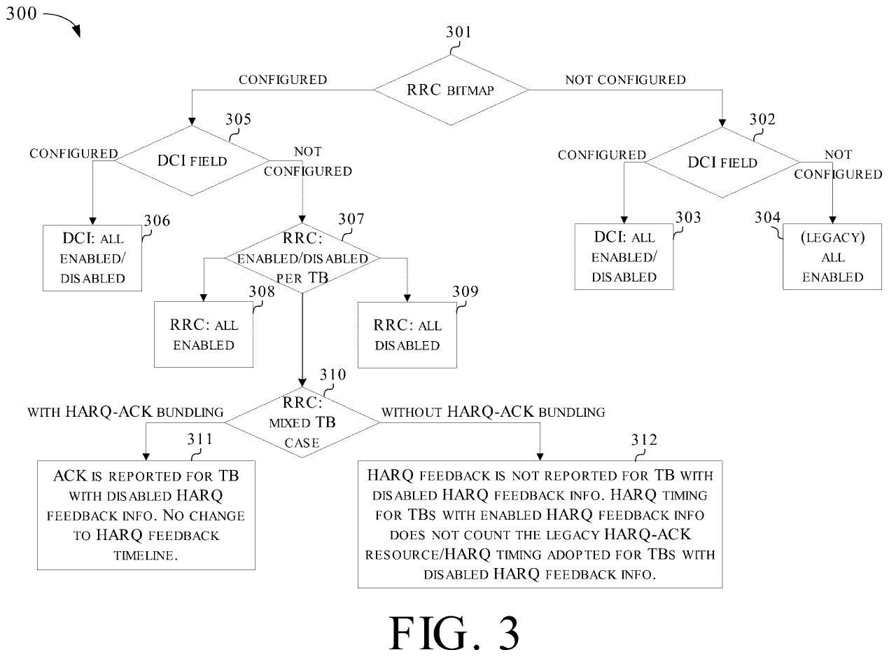

FIG. 3 illustrates an example scenario 300 of configuration indication for enabled/disabled HARQ feedback information for multi-TB in accordance with an implementation of the present disclosure. Scenario 300 depicts the UE operations with RRC-based indication and/or DCI-based indication for enabled/disabled HARQ feedback information is/are provided. To begin with, at 301, the UE determines whether an RRC bitmap (e.g., 2 bits for NB-IoT or 14 bits for eMTC) for enabled/disabled HARQ feedback information is configured. Subsequent to 301, if the RRC bitmap is not configured, UE operations proceed to 302 where the UE determines whether a DCI field (e.g., 1 bit) for enabled/disabled HARQ feedback information is configured. Subsequent to 302, if the DCI field is configured, UE operations proceed to 303 where the UE determines enabled HARQ feedback information for all TBs (e.g., DCI field=0 or “enabled”) or disabled HARQ feedback information for all TBs (e.g., DCI field=1 or “disabled”). Subsequent to 302, if the DCI field is not configured, UE operations proceed to 304 where the UE follows the legacy design by determining enabled HARQ feedback information for all TBs.

Subsequent to 301, if the RRC bitmap is configured, UE operations proceed to 305 where the UE determines whether a DCI field (e.g., 1 bit) for enabled/disabled HARQ feedback information is configured. Subsequent to 305, if the DCI field is configured, UE operations proceed to 306 where the UE determines enabled HARQ feedback information for all TBs (e.g., DCI field=0 or “enabled”) or disabled HARQ feedback information for all TBs (e.g., DCI field=1 or “disabled”). Subsequent to 305, if the DCI field is not configured, UE operations proceed to 307 where the UE determines whether the configured RRC bitmap indicates enabled/disabled HARQ feedback information for all TBs, or indicates enabled HARQ feedback information for some TBs and disabled HARQ feedback information for some other TBs. Subsequent to 307, if the configured RRC bitmap indicates enabled HARQ feedback information for all TBs, UE operations proceed to 308 where the UE determines enabled HARQ feedback information for all TBs. Subsequent to 307, if the configured RRC bitmap indicates disabled HARQ feedback information for all TBs, UE operations proceed to 309 where the UE determines disabled HARQ feedback information for all TBs.

Subsequent to 307, if the configured RRC bitmap indicates enabled HARQ feedback information for some TBs and disabled HARQ feedback information for some other TBs (i.e., mixed TB case), UE operations proceed to 310 where the UE determines whether HARQ-ACK bundling is configured. Subsequent to 310, if HARQ-ACK bundling is configured, UE operations proceed to 311 where the UE determines to report ACK for the TBs with disabled HARQ feedback information, i.e., the UE performs a logical AND operation of the HARQ feedbacks for all TBs and assumes 1 in the logical AND operation for the TBs with disabled HARQ feedback information. Accordingly, no change will occur to the HARQ feedback timeline. Subsequent to 310, if HARQ-ACK bundling is not configured, UE operations proceed to 312 where the UE determines not to report the HARQ feedbacks for the TBs with disabled HARQ feedback information, i.e., only report the HARQ feedbacks for the TBs with enabled HARQ feedback information. Accordingly, the HARQ timing for the TBs with enabled HARQ feedback information does not include/count the legacy HARQ-ACK resource/HARQ timing adopted for the TBs with disabled HARQ feedback information.

### Illustrative Implementations

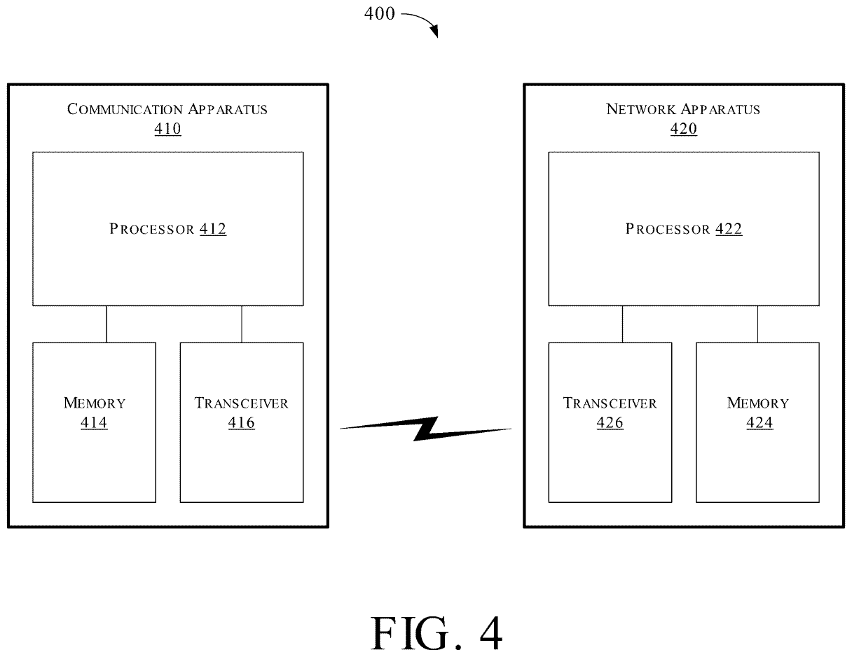

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to HARQ enhancements for multi-TB scheduling in an IoT system, including scenarios/schemes described above as well as process 500 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 410 may also be a part of a machine type apparatus, which may be an IoT, NB-IoT, eMTC, IloT UE such as an immobile or a stationary apparatus, a home apparatus, a roadside unit (RSU), a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of an electronic apparatus, which may be a network node such as a satellite, a BS, a small cell, a router or a gateway of an IoT network. For instance, network apparatus 420 may be implemented in a satellite or an eNB/gNB/TRP in a 4G/5G, NR, IoT, NB-IoT or IloT network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks, including HARQ enhancements for multi-TB scheduling, in a device (e.g., as represented by communication apparatus 410) and a network node (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, transceiver 416 may be capable of wirelessly communicating with different types of UEs and/or wireless networks of different radio access technologies (RATs), such as 4G/5G/B5G/6G. In some implementations, transceiver 416 may be equipped with a plurality of antenna ports (not shown) such as, for example, four antenna ports. That is, transceiver 416 may be equipped with multiple transmit antennas and multiple receive antennas for multiple-input multiple-output (MIMO) wireless communications. In some implementations, network apparatus 420 may also include a transceiver 426 coupled to processor 422. Transceiver 426 may include a transceiver capable of wirelessly transmitting and receiving data. In some implementations, transceiver 426 may be capable of wirelessly communicating with different types of UEs of different RATs. In some implementations, transceiver 426 may be equipped with a plurality of antenna ports (not shown) such as, for example, four antenna ports. That is, transceiver 426 may be equipped with multiple transmit antennas and multiple receive antennas for MIMO wireless communications.

In some implementations, communication apparatus 410 may further include a memory 414 coupled to processor 412 and capable of being accessed by processor 412 and storing data therein. In some implementations, network apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 410 and network apparatus 420 may be a communication entity capable of communicating with each other using various proposed schemes in accordance with the present disclosure. For illustrative purposes and without limitation, a description of capabilities of communication apparatus 410, as an IoT UE (e.g., an NB-IoT UE or an eMTC UE), and network apparatus 420, as a network node (e.g., satellite or BS), is provided below.

According to some schemes of the present disclosure, processor 412 may receive, via transceiver 416, a configuration from network apparatus 420, wherein the configuration indicates disabled or enabled HARQ feedback information for each or all of a plurality of HARQ processes. Also, processor 412 may receive, via transceiver 416, a DCI from network apparatus 420, wherein the DCI indicates a scheduling of multiple TBs associated with the HARQ processes in a NPDSCH. Then, processor 412 may perform, via transceiver 416, a NPDSCH reception for the TBs based on the DCI. After that, processor 412 may determine whether to report one or more HARQ feedbacks corresponding to the TBs based on the configuration.

In some implementations, the determining of whether to report the one or more HARQ feedbacks corresponding to the TBs based on the configuration may include: determining to report the one or more HARQ feedbacks corresponding to the TBs associated with the HARQ processes with enabled HARQ feedback information as indicated by the configuration; and determining not to report any HARQ feedback corresponding to the TBs associated with the HARQ processes with disabled HARQ feedback information as indicated by the configuration.

In some implementations, in an event that a parameter indicating HARQ-ACK bundling is configured, the one or more HARQ feedbacks may include a single HARQ feedback generated by performing a logical AND operation of multiple HARQ feedbacks corresponding to the TBs associated with the HARQ processes with enabled HARQ feedback information, or by performing a logical AND operation of multiple HARQ feedbacks corresponding to the TBs and assuming 1 in the logical AND operation for the TBs associated with the HARQ processes with disabled HARQ feedback information.

In some implementations, in an event that a parameter indicating HARQ-ACK bundling is not configured, the one or more HARQ feedbacks may include one or multiple HARQ feedbacks, each corresponding to a respective one of to the TBs associated with the HARQ processes with enabled HARQ feedback information.

In some implementations, the TBs associated with the HARQ processes with enabled HARQ feedback information may be configured in multiple TB bundles, and the one or more HARQ feedbacks may include multiple HARQ feedbacks generated by performing a logical AND operation of HARQ feedbacks across all TBs in each of the TB bundles.

In some implementations, the TBs may be configured in multiple TB bundles, and the one or more HARQ feedbacks may include one or multiple HARQ feedbacks generated by performing a logical AND operation of HARQ feedbacks across all TBs and assuming 1 in the logical AND operation for the TBs associated with the HARQ processes with disabled HARQ feedback information in each of the TB bundles.

In some implementations, processor 412 may also determine not to perform DCI monitoring in a first period of time subsequent to the reporting the one or more HARQ feedbacks, in an event that at least one of the TBs is associated with the HARQ processes with enabled HARQ feedback information.

In some implementations, the first period of time may include a RTT (e.g., UE_eNB_RTT) between communication apparatus 410 and network apparatus 420, or an offset (e.g., K_{mac}) for delaying an application of a DL configuration indicated by a MAC CE command on a PDSCH.

In some implementations, processor 412 may also determine not to perform DCI monitoring in a second period of time subsequent to the NPDSCH reception, in an event that all of the TBs are associated with the HARQ processes with disabled HARQ feedback information.

In some implementations, the second period of time may include a half-duplex guard period (e.g., Type B half-duplex guard period (1ms)).

### Illustrative Processes

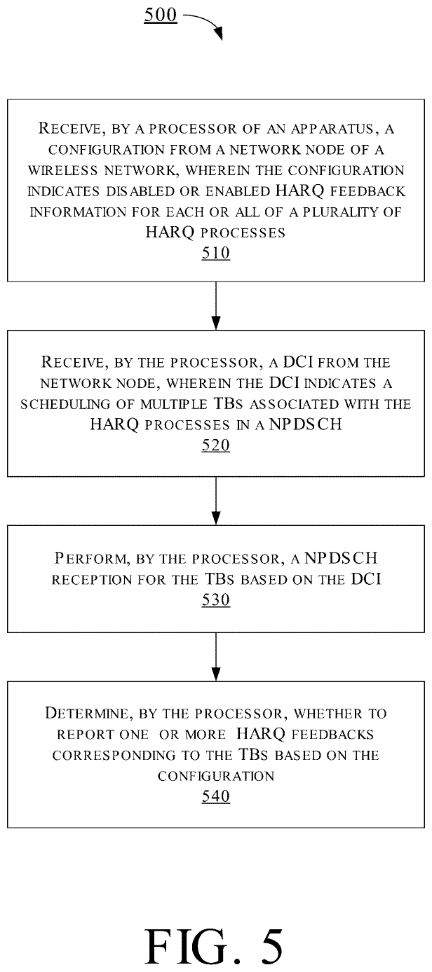

FIG. 5 illustrates an example process 500 in accordance with an implementation of the present disclosure. Process 500 may be an example implementation of above scenarios/schemes, whether partially or completely, with respect to HARQ enhancements for multi-TB scheduling in an IoT system. Process 500 may represent an aspect of implementation of features of communication apparatus 410. Process 500 may include one or more operations, actions, or functions as illustrated by one or more of blocks 510 to 540. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410. Process 500 may begin at block 510.

At 510, process 500 may involve processor 412 of communication apparatus 410 receiving, via transceiver 416, a configuration from a network node (e.g., network apparatus 420) of a wireless network (e.g., an IoT (NTN) network), wherein the configuration indicates disabled or enabled HARQ feedback information for each or all of a plurality of HARQ processes. Process 500 may proceed from 510 to 520.

At 520, process 500 may involve processor 412 receiving, via transceiver 416, a DCI from the network node, wherein the DCI indicates a scheduling of multiple TBs associated with the HARQ processes in a NPDSCH. Process 500 may proceed from 520 to 530.

At 530, process 500 may involve processor 412 performing, via transceiver 416, a NPDSCH reception for the TBs based on the DCI. Process 500 may proceed from 530 to 540.

At 540, process 500 may involve processor 412 determining whether to report one or more HARQ feedbacks corresponding to the TBs based on the configuration.

In some implementations, the determining of whether to report the one or more HARQ feedbacks corresponding to the TBs based on the configuration may include: determining to report the one or more HARQ feedbacks corresponding to the TBs associated with the HARQ processes with enabled HARQ feedback information as indicated by the configuration; and determining not to report any HARQ feedback corresponding to the TBs associated with the HARQ processes with disabled HARQ feedback information as indicated by the configuration.

In some implementations, in an event that a parameter indicating HARQ-ACK bundling is configured, the one or more HARQ feedbacks may include a single HARQ feedback generated by performing a logical AND operation of multiple HARQ feedbacks corresponding to the TBs associated with the HARQ processes with enabled HARQ feedback information, or by performing a logical AND operation of multiple HARQ feedbacks corresponding to the TBs and assuming 1 in the logical AND operation for the TBs associated with the HARQ processes with disabled HARQ feedback information.

In some implementations, in an event that a parameter indicating HARQ-ACK bundling is not configured, the one or more HARQ feedbacks may include one or multiple HARQ feedbacks, each corresponding to a respective one of to the TBs associated with the HARQ processes with enabled HARQ feedback information.

In some implementations, the TBs associated with the HARQ processes with enabled HARQ feedback information may be configured in multiple TB bundles, and the one or more HARQ feedbacks may include multiple HARQ feedbacks generated by performing a logical AND operation of HARQ feedbacks across all TBs in each of the TB bundles.

In some implementations, the TBs may be configured in multiple TB bundles, and the one or more HARQ feedbacks may include one or multiple HARQ feedbacks generated by performing a logical AND operation of HARQ feedbacks across all TBs and assuming 1 in the logical AND operation for the TBs associated with the HARQ processes with disabled HARQ feedback information in each of the TB bundles.

In some implementations, process 500 may further involve processor 412 determining not to perform DCI monitoring in a first period of time subsequent to the reporting the one or more HARQ feedbacks, in an event that at least one of the TBs is associated with the HARQ processes with enabled HARQ feedback information.

In some implementations, the first period of time may include a RTT (e.g., UE_eNB_RTT) between communication apparatus 410 and network apparatus 420, or an offset (e.g., K_{mac}) for delaying an application of a DL configuration indicated by a MAC CE command on a PDSCH.

In some implementations, process 500 may involve processor 412 determining not to perform DCI monitoring in a second period of time subsequent to the NPDSCH reception, in an event that all of the TBs are associated with the HARQ processes with disabled HARQ feedback information.

In some implementations, the second period of time may include a half-duplex guard period (e.g., Type B half-duplex guard period (1 ms)).

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a configuration from a network node of a wireless network, wherein the configuration indicates disabled or enabled hybrid automatic repeat request (HARQ) feedback information for each or all of a plurality of HARQ processes;
receiving, by the processor, a downlink control information (DCI) from the network node, wherein the DCI indicates a scheduling of multiple transport blocks (TBs) associated with the HARQ processes in a narrowband physical downlink shared channel (NPDSCH);
performing, by the processor, a NPDSCH reception for the TBs based on the DCI; and
determining, by the processor, whether to report one or more HARQ feedbacks corresponding to the TBs based on the configuration.

2. The method of claim 1, wherein the determining of whether to report the one or more HARQ feedbacks corresponding to the TBs based on the configuration comprises:
determining to report the one or more HARQ feedbacks corresponding to the TBs associated with the HARQ processes with enabled HARQ feedback information as indicated by the configuration; and
determining not to report any HARQ feedback corresponding to the TBs associated with the HARQ processes with disabled HARQ feedback information as indicated by the configuration.

3. The method of claim 1, wherein, in an event that a parameter indicating HARQ-acknowledgement (ACK) bundling is configured, the one or more HARQ feedbacks comprises a single HARQ feedback generated by performing a logical AND operation of multiple HARQ feedbacks corresponding to the TBs associated with the HARQ processes with enabled HARQ feedback information, or by performing a logical AND operation of multiple HARQ feedbacks corresponding to the TBs and assuming 1 in the logical AND operation for the TBs associated with the HARQ processes with disabled HARQ feedback information.

4. The method of claim 1, wherein, in an event that a parameter indicating HARQ-ACK bundling is not configured, the one or more HARQ feedbacks comprises one or multiple HARQ feedbacks, each corresponding to a respective one of the TBs associated with the HARQ processes with enabled HARQ feedback information.

5. The method of claim 1, wherein the TBs associated with the HARQ processes with enabled HARQ feedback information are configured in multiple TB bundles, and the one or more HARQ feedbacks comprises multiple HARQ feedbacks generated by performing a logical AND operation of HARQ feedbacks across all TBs in each of the TB bundles.

6. The method of claim 1, wherein the TBs are configured in multiple TB bundles, and the one or more HARQ feedbacks comprises one or multiple HARQ feedbacks generated by performing a logical AND operation of HARQ feedbacks across all TBs and assuming 1 in the logical AND operation for the TBs associated with the HARQ processes with disabled HARQ feedback information in each of the TB bundles.

7. The method of claim 1, further comprising:
determining not to perform DCI monitoring in a first period of time subsequent to reporting the one or more HARQ feedbacks, in an event that at least one of the TBs is associated with the HARQ processes with enabled HARQ feedback information.

8. The method of claim 7, wherein the first period of time comprises a round-trip time (RTT) between the apparatus and the network node, or an offset for delaying an application of a downlink (DL) configuration indicated by a medium access control (MAC) control element (CE) command on a PDSCH.

9. The method of claim 2, further comprising:
determining not to perform DCI monitoring in a second period of time subsequent to the NPDSCH reception, in an event that all of the TBs are associated with the HARQ processes with disabled HARQ feedback information.

10. The method of claim 9, wherein the second period of time comprises a half-duplex guard period.

11. An apparatus, comprising:
a transceiver which, during operation, wirelessly communicates with a network node of a wireless network; and
a processor communicatively coupled to the transceiver such that, during operation, the processor performs operations comprising:
receiving, via the transceiver, a configuration from the network node, wherein the configuration indicates disabled or enabled hybrid automatic repeat request (HARQ) feedback information for each or all of a plurality of HARQ processes;
receiving, via the transceiver, a downlink control information (DCI) from the network node, wherein the DCI indicates a scheduling of multiple transport blocks (TBs) associated with the HARQ processes in a narrowband physical downlink shared channel (NPDSCH);
performing, via the transceiver, a NPDSCH reception for the TBs based on the DCI; and
determining whether to report one or more HARQ feedbacks corresponding to the TBs based on the configuration.

12. The apparatus of claim 11, the determining of whether to report the one or more HARQ feedbacks corresponding to the TBs based on the configuration comprises:
determining to report the one or more HARQ feedbacks corresponding to the TBs associated with the HARQ processes with enabled HARQ feedback information as indicated by the configuration; and
determining not to report any HARQ feedback corresponding to the TBs associated with the HARQ processes with disabled HARQ feedback information as indicated by the configuration.

13. The apparatus of claim 11, wherein, in an event that a parameter indicating HARQ-acknowledgement (ACK) bundling is configured, the one or more HARQ feedbacks comprises a single HARQ feedback generated by performing a logical AND operation of multiple HARQ feedbacks corresponding to the TBs associated with the HARQ processes with enabled HARQ feedback information, or by performing a logical AND operation of multiple HARQ feedbacks corresponding to the TBs and assuming 1 in the logical AND operation for the TBs associated with the HARQ processes with disabled HARQ feedback information.

14. The apparatus of claim 11, wherein, in an event that a parameter indicating HARQ-ACK bundling is not configure, the one or more HARQ feedbacks comprises one or multiple HARQ feedbacks, each corresponding to a respective one of to the TBs associated with the HARQ processes with enabled HARQ feedback information.

15. The apparatus of claim 11, wherein the TBs associated with the HARQ processes with enabled HARQ feedback information are configured in multiple TB bundles, and the one or more HARQ feedbacks comprises multiple HARQ feedbacks generated by performing a logical AND operation of HARQ feedbacks across all TBs in each of the TB bundles.

16. The apparatus of claim 11, wherein the TBs are configured in multiple TB bundles, and the one or more HARQ feedbacks comprises one or multiple HARQ feedbacks generated by performing a logical AND operation of HARQ feedbacks across all TBs and assuming 1 in the logical AND operation for the TBs associated with the HARQ processes with disabled HARQ feedback information in each of the TB bundles.

17. The apparatus of claim 11, wherein, during operation, the processor further performs operations comprising:
determining not to perform DCI monitoring in a first period of time subsequent to the reporting the one or more HARQ feedbacks, in an event that at least one of the TBs is associated with the HARQ processes with enabled HARQ feedback information.

18. The apparatus of claim 17, wherein the first period of time comprises a round-trip time (RTT) between the apparatus and the network node, or an offset for delaying an application of a downlink (DL) configuration indicated by a medium access control (MAC) control element (CE) command on a PDSCH.

19. The apparatus of claim 11, wherein, during operation, the processor further performs operations comprising:
determining not to perform DCI monitoring in a second period of time subsequent to the NPDSCH reception, in an event that all of the TBs are associated with the HARQ processes with disabled HARQ feedback information.

20. The apparatus of claim 19, wherein the second period of time comprises a half-duplex guard period.
